(19) United States
(12) Patent Application Publication
(10) Pub. No.: US 2026/0287406 A1
(43) Pub. Date: Sep. 24, 2026

(54) FLOWMETER AND PRODUCT FAMILY OF FLOWMETERS

(71) Applicant: Endress+Hauser Flowtec AG, Reinach (CH)

(72) Inventors: Steffen Ziegler, Schopfheim (DE); Markus Beissert, Auggen (DE); Lars Dreher, Ballrechten Dottingen (DE); Walter Rombach, Rheinfelden (DE); Janik Hemmer, Schliengen (DE)

(21) Appl. No.: 19/478,021

(22) PCT Filed: Apr. 16, 2024
(86) PCT No.: PCT/EP2024/060299

§ 371 Date: Oct. 23, 2025

(30) Foreign Application Priority Data
Apr. 25, 2023 (DE) 10 2023 110 589.2

(51) Int. Cl. G01F 15/061; G01F 1/58; G01F 15/14; G01F 15/18

(52) U.S. Cl. CPC G01F 15/061; G01F 1/586; G01F 1/588; G01F 15/14; G01F 15/18

(57) ABSTRACT

The present disclosure relates to a flowmeter comprising a sensor having at least one sensor measuring unit for determining a process variable of the medium. The sensor has a sensor housing, where the sensor measuring unit is at least partly arranged in the sensor housing. The sensor has sensor electronics; and a transmitter, where the sensor electronics are arranged in a transmitter housing cover that is designed such that it can be arranged directly on a sensor-transmitter interface of the sensor housing and also on a transmitter holder which is external to the sensor housing. The transmitter housing cover is configured to be arranged on the sensor-transmitter interface or the transmitter holder. The transmitter electronics have a radio module which is configured to form a wireless connection between the transmitter electronics and an external receiver.

The invention relates to a flowmeter and to a product family of flowmeters.

In automation technology, particularly in process automation, flowmeters that capture and/or influence process variables are frequently used. For detecting process variables, sensors that are integrated, for example, into fill-level measuring devices, flowmeters, pressure and temperature measuring devices, pH-redox potential meters, conductivity meters, etc., are used to detect the respective process variables, such as fill level, flow, pressure, temperature, pH level, or conductivity. Actuators, such as for example valves or pumps, are used to influence process variables. The flow rate of a fluid in a pipeline section or a fill level in a container can thus be altered by means of actuators. In principle, all devices which are process-oriented and which supply or process process-relevant information are referred to as flowmeters. In connection with the invention, flowmeters are therefore also understood as remote I/O's, radio adapters, or, in general, electronic measuring components that are disposed at the field level.

Flowmeters are, in particular, Coriolis, ultrasound, vortex, thermal, and/or magnetic inductive flowmeters.

Flowmeters of the type described also comprise an electronics housing which, as proposed, e.g., in U.S. Pat. No. 6,397,683 A or WO 00/36379 A1, can be arranged remotely from the sensing element and connected thereto only via a flexible cable or which, as shown, e.g., in EP 903 651 A1 or EP 1 008 836 A1, is arranged directly on the sensor or on a sensor housing which separately houses the sensor.

The object of the invention is to provide an alternative solution.

The object is achieved by the flowmeter according to claim 1 and by the product family according to claim 15.

The flowmeter for automation technology according to the invention comprises:
a sensor for determining a process variable of a medium,
   wherein the sensor has a measuring tube for guiding the medium, in particular a flowable medium,
   wherein the sensor has at least one sensor measuring unit for determining the process variable of the medium,
   wherein the sensor has a sensor housing which is arranged on an outer surface of the measuring tube,
   wherein the sensor measuring unit is at least partially arranged in the sensor housing,
   wherein the sensor has sensor electronics configured to operate the at least one sensor measuring unit with an operating signal and to determine the process variable depending upon a measuring signal provided by the at least one sensor measuring unit,
a transmitter,
   wherein the transmitter has a transmitter housing,
   wherein the transmitter housing has a transmitter housing cover which forms the front portion of the transmitter housing,
   wherein the sensor electronics are arranged in the transmitter housing cover,
   wherein the transmitter, in particular the transmitter housing cover, is designed in such a way that it can be arranged directly on a sensor-transmitter interface of the sensor housing and also on a transmitter holder which is external, i.e., detached or separated from the sensor housing,
   wherein the transmitter, in particular the transmitter housing cover, is configured to be arranged on the sensor-transmitter interface or the transmitter holder,
   wherein the transmitter has transmitter electronics that communicate with the sensor electronics,
   wherein the transmitter electronics are arranged in the transmitter housing,
      wherein the transmitter electronics have a radio module supporting Bluetooth, WLAN, ZigBee, ANT, ANT+, NFC, Long Range Wide Area Network, GSM, GPRS, EDGE, LTE, 5G, or other radio standards, which module is configured to form a wireless connection between the transmitter electronics and an external receiver.

Advantageous embodiments of the invention are the subject matter of the dependent claims.

One embodiment provides that the transmitter housing cover have a housing cover base body, in particular one that is substantially tub-shaped or pot-shaped,
wherein the housing cover base body delimits a housing cover cavity and has an open end,
wherein the sensor electronics are located exclusively in the housing cover cavity.

One embodiment provides that the transmitter housing cover have a display,
wherein the display is arranged in the transmitter housing cover in such a way that it can be viewed through a viewing window in a front surface of the transmitter housing cover.

One embodiment provides that the flowmeter further comprise:
a transmitter adapter, which is arranged on the sensor housing, in particular on the sensor-transmitter interface,
wherein the transmitter adapter comprises an adapter housing,
wherein the transmitter adapter has adapter electronics which are arranged at least partially in the adapter housing and are in communication with the transmitter electronics and the sensor electronics,
wherein communication, i.e., transmission of the measuring signal and/or the operating signal, between the sensor measuring unit and the sensor electronics always takes place via the adapter electronics.

One embodiment provides that the adapter housing have dimensions and/or housing geometry identical to those of the transmitter housing, and preferably differ from the transmitter housing in that it has no viewing window.

For example, the transmitter adapter can have an adapter housing that is identical in shape and dimensions to the transmitter housing, but differs only in that it does not have a display and therefore also does not have a viewing window.

One embodiment provides that the transmitter housing have a transmitter cover arranged on the back of the transmitter housing cover,
wherein the transmitter cover is designed in such a way that the transmitter can be connected via it to the transmitter holder, in particular a support rail and preferably a top-hat rail.

One embodiment provides that a width of the transmitter housing, i.e., an extension of the transmitter housing in the longitudinal direction of the measuring tube, be less than 150 millimeters, in particular less than 100 millimeters,
wherein a length of the transmitter housing, i.e., an extension of the transmitter housing perpendicular to the longitudinal direction of the measuring tube, is less than 250 millimeters, in particular less than 200 millimeters.

One embodiment provides that the sensor electronics and the transmitter electronics each have electronic components that are arranged on exactly one common circuit board.

One embodiment provides that the sensor electronics and the transmitter electronics each have electronic components that are arranged on exactly two circuit boards, in particular arranged one above the other and parallel to each other.

This allows the dimensions of the sensor-transmitter interface to be maintained when designing the transmitter housing regardless of the measuring tube nominal diameter, while still accommodating the electronic components in the transmitter housing. This is particularly challenging for sensors in which the measuring tube has only a small nominal diameter.

One embodiment provides that the sensor housing, the transmitter housing, and/or the adapter housing be or be made of cast aluminum.

One embodiment provides that the sensor-transmitter interface be designed as a recess, in particular a tub-shaped recess, in the sensor housing,
wherein the transmitter and/or the transmitter adapter can be arranged in the recess, in particular in a manner fitting the shape.

This results in a flowmeter in which the transmitter housing does not protrude from the sensor housing, but is arranged separately in the sensor housing. This results in an overall more compact flowmeter. It is particularly advantageous if the maximum distance from the transmitter housing to the measuring tube is not greater than the maximum distance from the sensor housing to the measuring tube.

One embodiment provides that only the transmitter have a device connection, in particular two device connections, via which the individual electronics are supplied with power.

One embodiment provides that the device connection, in particular the two device connections, be arranged in the transmitter cover.

One embodiment provides that the flowmeter be a magnetic inductive flowmeter,
wherein the at least one sensor measuring unit has a magnetic-field-generating device and at least two measuring electrodes for tapping a flow-velocity-dependent measuring voltage in the medium to be guided.

A product family of flowmeters for automation technology according to the invention comprises:
at least two flowmeters according to the invention,
   wherein the sensors of the flowmeters differ in their measuring tube nominal diameters,
   wherein the measuring tube nominal diameter is selected from a nominal diameter range of 15 to 300 millimeters,
   wherein the sensor housings of the flowmeters differ in their dimensions and/or housing geometry,
   wherein the sensor housings each have identically designed sensor transmitter interfaces so that transmitters and/or transmitter adapters can be connected that are designed identically for all sensor housings.

The invention is explained in greater detail with reference to the following figures, in which:

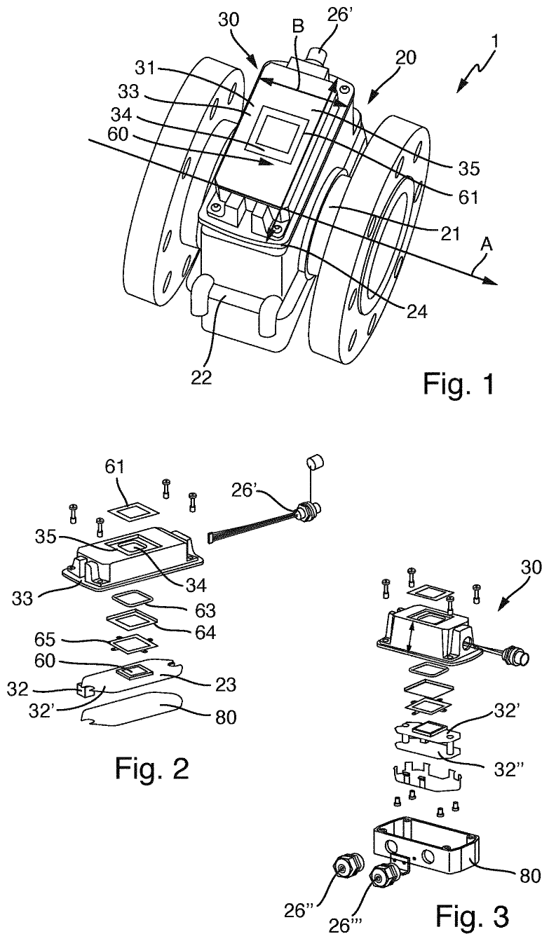

FIG. 1 is a perspectival view of an embodiment of the flowmeter;

FIG. 2 is an exploded view of a first embodiment of the transmitter;

FIG. 3 is an exploded view of a second embodiment of the transmitter;

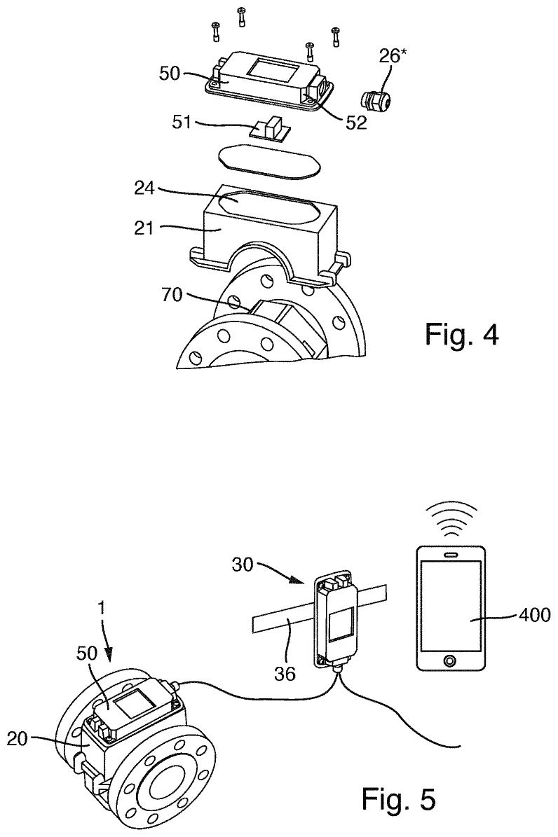

FIG. 4 is an exploded view of an embodiment of an alternative flowmeter;

FIG. 5 is a perspectival view of an embodiment of an alternative flowmeter;

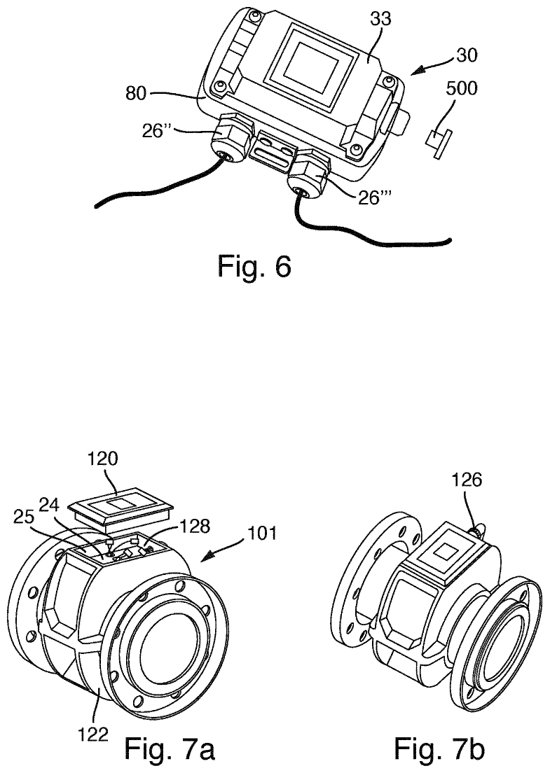

FIG. 6 is a perspectival view of a transmitter arranged remotely from the sensor;

FIG. 7 shows perspectival views of an alternative embodiment of the flowmeter;

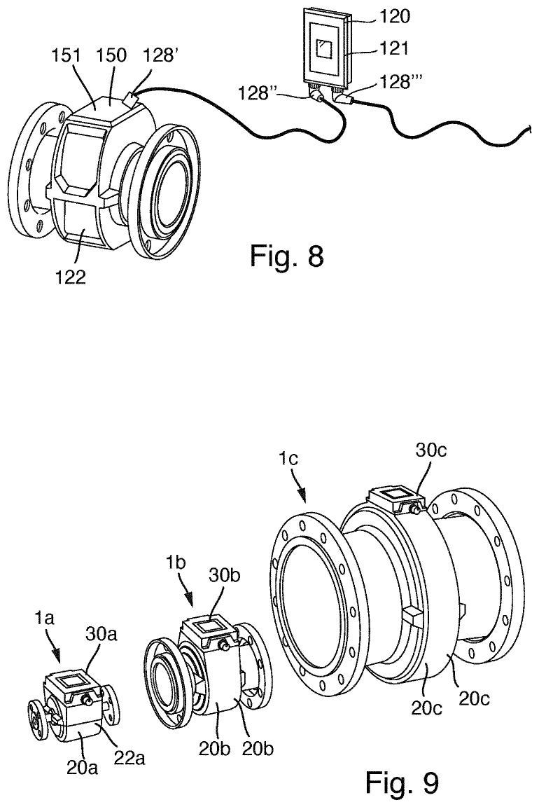

FIG. 8 is a perspectival view of an alternative transmitter arranged remotely from the sensor;

FIG. 9 is a perspectival view of a product family; and

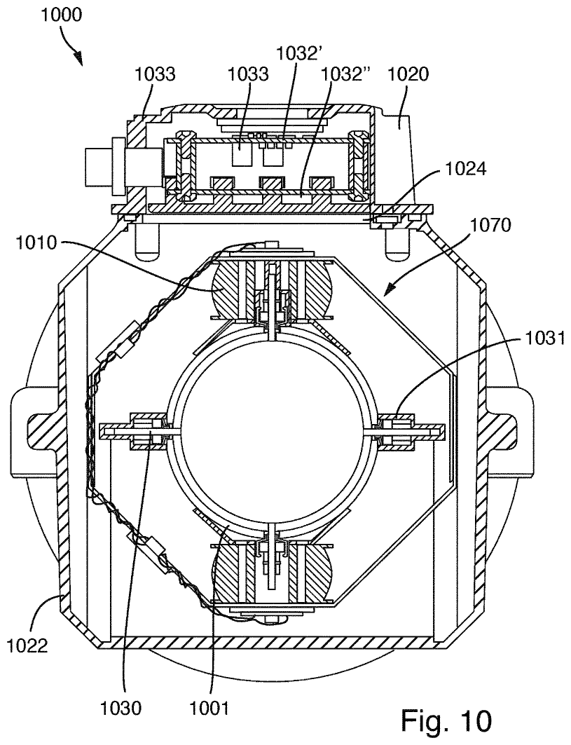

FIG. 10 is a cross-sectional view through a magnetic inductive flowmeter.

FIG. 1 shows a perspectival view of an embodiment of a flowmeter 1 used in automation technology. The flowmeter 1 according to the invention comprises a sensor 20 for determining a process variable of a medium and a transmitter 30, in which electronic components are housed for operating the sensor 20, for evaluating process data or measurement data, and for communicating measured process data or measurement data to a higher-level unit (receiver) or a handheld device (smartphone, laptop, tablet, or the like). The sensor 20 shown has a measuring tube 21 for guiding the medium, in particular a flowable medium. The measuring tube can be made of metal, plastic, glass, or ceramic, or can comprise these. A sensor housing 22 of the sensor 20, which is arranged on an outer surface of the measuring tube 21, encloses at least in portions a sensor measuring unit (see FIG. 10) for determining the process variable of the medium. This unit is arranged in or on, i.e., on an outer surface of, the measuring tube 21. Another essential feature of the sensor are the sensor electronics (see FIG. 10), which are designed to operate the at least one sensor measuring unit with an operating signal and to determine the process variable depending upon a measuring signal provided by the at least one sensor measuring unit. The sensor electronics can also be configured to supply the sensor measuring unit with energy.

The transmitter 30 has a transmitter housing 31, which in the illustrated embodiment comprises for example two, in particular metallic, housing shells, which can be connected to one another in a form-fitting and force-fitting manner, or in a material-fitting manner. The transmitter housing 31 has a transmitter housing cover 33 which forms the front portion of the transmitter housing 31. The housing shape of the transmitter housing cover 33 is irrelevant here. It can be round, oval, square, rectangular, or square with rounded corners. The transmitter housing cover 33 can be designed as a pressure housing, which does not require post-processing by threading, milling, drilling, etc. The transmitter housing cover 33 covers or closes an opening or receptacle of the transmitter housing 31, through which electrical connectors for connecting the sensor measuring unit to the sensor electronics (see FIGS. 2 and 3) are located. The opening forms the sensor-transmitter interface 24. The sensor electronics themselves are arranged in the transmitter housing cover 33. This means that the sensor housing is free of sensor electronics. Only electrical connectors designed to connect the sensor electronics to the sensor measuring unit or to subunits of the sensor measuring unit extend into the sensor housing. The transmitter 30, in particular the transmitter housing cover 33, is designed such that it can be arranged directly on a sensor-transmitter interface 24 of the sensor housing 22 and also on an external transmitter holder (see FIG. 5), i.e., detached or separated from the sensor housing 22. Accordingly, the transmitter 30, in particular the transmitter housing cover 33, is adapted to be arranged on the sensor-transmitter interface 24 or the transmitter holder. The advantage of this is that the measured values shown on the display can be read in a user-friendly manner, even if the sensor is difficult to access. The sensor housing 22, the transmitter housing 31, and/or the adapter housing 52 are each formed from cast aluminum.

In addition to the sensor electronics, the transmitter 30 has transmitter electronics (see FIGS. 2 and 3) which are in communication with the sensor electronics and are also arranged in the transmitter housing 31. The transmitter electronics according to the invention have a radio module (see FIGS. 2 and 3) to support Bluetooth, WLAN, ZigBee, ANT, ANT+, NFC, Long Range Wide Area Network, GSM, GPRS, EDGE, LTE, 5G, or other radio standards. The radio module is intended to establish a wireless connection between the transmitter electronics and an external receiver.

In the illustrated embodiment, the transmitter housing cover 33 has a display 60 with which the determined process data and sensor data are output. The display 60 is arranged in the transmitter housing cover 33 such that it can be viewed through a viewing window 34 in a front surface 35 of the transmitter housing cover 33. Alternatively, the viewing window can also be located in a side window of the transmitter housing cover 33.

In the illustrated embodiment, only the transmitter 30 has a device connection 26′, via which the individual electronics are supplied with power. Although a radio module is provided to form a wireless connection via which process data and sensor data can be exchanged with an external unit, the device connection can also be configured to exchange process and sensor data with an external unit via a wired connection.

A width B of the transmitter housing 31, i.e., an extent of the transmitter housing 31 in the longitudinal direction A of the measuring tube 21, is less than 150 millimeters, in particular less than 100 millimeters. A length L of the transmitter housing 31, i.e., an extent of the transmitter housing 31 perpendicular to the longitudinal direction A of the measuring tube 21, is less than 250 millimeters, in particular less than 200 millimeters.

FIG. 2 shows an exploded view of a first embodiment of the transmitter 30. The transmitter housing of the transmitter 30 has a transmitter housing cover 33 which forms the front portion of the transmitter housing. The transmitter housing cover 33 has a housing cover base body 37, in particular substantially tub-shaped or pot-shaped, which delimits a housing cover cavity 38 and has an open end 39 through which the electronics can be inserted. The sensor electronics and also the transmitter electronics are arranged exclusively in the housing cover cavity 38.

Arranged in or on the transmitter housing cover 33 are a display 60, a display front glass 61, a display glass 64, a display frame 65, a seal 63 for sealing the viewing window 34, a device connection 26′ via which a measurement signal can be output and the flowmeter 1 supplied with energy, sensor electronics 23, transmitter electronics 32, which are arranged together with the sensor electronics 23 on exactly one circuit board 32′ and are formed by electronic components, a radio module 133, and a transmitter cover 80, which closes off an open rear side of the transmitter cover 33. The sensor electronics 23 and the transmitter electronics 32 are arranged together in the transmitter housing cover 33 and are in communication with each other. In this way, the sensor electronics 23 provide measurement data to the transmitter electronics. The measurement data are then forwarded to an external receiver via a wireless connection using a radio module 133, which supports Bluetooth, WLAN, ZigBee, ANT, ANT+, NFC, Long Range Wide Area Network, GSM, GPRS, EDGE, LTE, 5G, or other radio standards. The sensor and transmitter electronics 23, 32 each comprise electronic components such as electrical capacitors, resistors, transistors, etc.

The illustrated transmitter 30 is designed such that it can be arranged directly on a sensor-transmitter interface of the sensor housing and is configured to be arranged on the sensor-transmitter interface.

The transmitter housing cover 33 further comprises a display 60 via which the sensor can be operated and which is configured to output process and/or sensor data. The display 60 is arranged in the transmitter housing cover 33 such that it can be viewed through a viewing window 34 in a front surface 35 of the transmitter housing cover 33. In the illustrated embodiment, the display 60 is arranged on the circuit board 32′ and fixed by a display frame 65. A display glass 64 is arranged on the display 60. To seal the viewing window 34 against liquids, a display seal 63, in the illustrated case an O-ring, is arranged or pressed in between the display glass and the inner surface of the transmitter cover 33. A display front glass 61 is arranged on an outer surface of the transmitter cover 33.

The transmitter housing 31 has a transmitter cover 80. This cover is arranged on the rear side of the transmitter housing cover 33 and, in the embodiment shown, is substantially planar.

FIG. 3 shows an exploded view of a second embodiment of the transmitter 30. The main differences from the design of FIG. 2 are the use of two circuit boards 32′, 32″ which are arranged substantially parallel to each other, the dimensioning of the transmitter housing cover 33, and the design of the transmitter cover 80.

In the illustrated embodiment, the sensor electronics 23 and the transmitter electronics 32 each have electronic components that are distributed on exactly two circuit boards 32′, 32″, in particular arranged one above the other and parallel to each other. This allows the length L of the transmitter housing cover 33 to be reduced. At the same time, the height H of the transmitter housing cover 33 increases.

The transmitter cover 80 shown is tub-shaped and has two device connections 26″, 26′″. The transmitter cover 80 is preferably designed such that the transmitter 30 can be connected via it to the transmitter holder (see FIG. 5), in particular a support rail and preferably a top-hat rail. For this purpose, it has at least one, in particular at least two, angle elements that can be fixed in a support rail. The transmitter cover 80 is designed as a wall housing and is therefore suitable for mounting on a wall or in a control cabinet. Alternatively, the transmitter cover 80 can be such that it can be positively attached to a cylindrical body (e.g., a pipe or the process line) and can be non-positively connected to the cylindrical body via a counterpiece.

FIG. 4 shows an exploded view of an embodiment of an alternative flowmeter. Instead of a transmitter housing, a transmitter adapter 50 is arranged on the sensor housing 21, in particular on the sensor-transmitter interface 24. The transmitter adapter 50 itself has an adapter housing 52 and adapter electronics 51, which are arranged at least partly in the adapter housing 52 and are in communication with the transmitter electronics (not shown) and the sensor electronics. This means that the transmitter adapter cannot independently output process and/or sensor data wirelessly to an external unit (receiver) or establish a connection to an external unit. Therefore, communication with the external unit exclusively via the transmitter adapter is not possible. Instead, the communication, i.e., transmission of the measuring signal and/or the operating signal, between the sensor measuring unit 70 and the sensor electronics (not shown) always takes place via the adapter electronics 51, and the communication with the external unit always takes place via the transmitter.

The pictured adapter housing 52 has dimensions and/or housing geometry identical to those of the transmitter housing 31 of FIGS. 1 through 3, and preferably differs from the transmitter housing only in that it has no viewing window and thus also no display.

The transmitter adapter 50 has a device connection 26* via which the adapter electronics 51 can be connected to the transmitter electronics via an electrical connector.

FIG. 5 shows a perspectival view of an embodiment of an alternative flowmeter 1 with a transmitter adapter 50 from FIG. 4. The transmitter adapter 50 is connected to the transmitter 30 via an electrical conductor (connector), in this case a data and supply cable. The process and sensor data are sent to the transmitter 30 via the electrical conductor. Furthermore, the sensor 20 is supplied with energy by the electrical conductor. The transmitter 30 is attached to a transmitter holder 36. The transmitter holder 36 can be a support rail and preferably a top-hat rail into which the transmitter 30 can be clicked. In this way, the transmitter 30 can be mounted on a control cabinet or a wall housing with a DinRail. The transmitter 30 is also connected to a power supply via another electrical conductor.

The transmitter 30, in particular the radio module arranged therein, is wirelessly connected to an external receiver 400. The external receiver 400 is a handheld device, in particular a smartphone. The dimensions of the smartphone are chosen to maintain a realistic size ratio to the transmitter 30.

FIG. 6 shows a perspectival view of a transmitter 30 arranged remotely from the sensor (not shown). The transmitter 30 has a transmitter cover 80 which is mechanically connected to the transmitter housing cover 33 and covers its rear side. The cover 80 has two device connections 26″, 26′″. The sensor electronics (in the transmitter 30) are electrically connected to the sensor measuring unit via the device connections 26″, and the transmitter electronics (also in the transmitter 30) and the sensor electronics are connected to a power supply by the device connections 26′″. A device connection 26′ of the transmitter 30, which is configured to connect the transmitter 30 to a power supply, is not in use and can be or is closed by a cover 500. Alternatively, an additional device connection (thus, a total of three device connections) can be provided via which the transmitter electronics are or can be connected to the sensor electronics. Data are transmitted via a data line, and the magnetic system is operated via a separate power line.

FIGS. 7a and 7b show perspectival views of an alternative design of the flowmeter. The flowmeter 101 shown differs from the flowmeter of FIGS. 1 to 5 in that the transmitter 120 and/or the transmitter adapter (see FIG. 8) can be arranged in an, in particular tub-shaped, recess 25 of the sensor housing 122, in particular in a manner fitting the shape. The recess 25 forms the sensor-transmitter interface 24. Furthermore, the recess 25 is designed to be complementary to the sensor housing 122. The resulting solution is very compact, and, in the recess 25, there can be at least one connector and/or at least one cable harness 128 with which the sensor electronics (not shown) arranged in the transmitter 120 can be connected to the sensor measuring unit arranged in the sensor housing 122.

In the solution shown, the sensor 122 has a device connection 126 through which the sensor measuring unit, the transmitter electronics, and/or the sensor electronics are supplied with power. Alternatively, multiple device connections are also possible. It can be advantageous or necessary to separate the power network line and the data line. This is necessary in particular for voltages higher than 60 V. Alternatively, instead of the sensor 122, the transmitter can have the device connection 126. In this case, the flowmeter 101 can be operated exclusively with an arranged transmitter 120 or an arranged transmitter adapter (see FIG. 8). FIG. 7b shows the finally assembled flowmeter 101.

FIG. 8 shows a perspectival view of an alternative embodiment in which the transmitter 120 is arranged remotely from the sensor 122. To make this possible, a transmitter adapter 150 is arranged in place of the transmitter 120 in the sensor-transmitter interface. For this purpose, it has a device plug 128′, via which it is electrically connected to the device connection 128″ of the transmitter 120 by an electrical conductor (connector). Via the electrical conductor, process and/or sensor data are conducted from the sensor measuring unit to the sensor electronics, and energy is provided to the sensor measuring unit. The transmitter adapter 150 corresponds to the transmitter adapter 50 of FIGS. 4 and 5 and therefore also has adapter electronics (not shown). The adapter electronics themselves do not have a radio module, but are designed exclusively to forward the process and/or sensor data (i.e., including measurement data) to the transmitter electronics (see FIG. 2/3). The adapter housing 151 of the transmitter adapter 150 is identical in its dimensions and geometry to the transmitter housing 121. The adapter housing 151 itself differs substantially from the transmitter housing 121 in that it does not have a viewing window for a display. The transmitter 120 itself also has another device connection 128′″, via which it is connected to a power supply. Alternatively, the transmitter 120 can have an electrical storage device (battery, accumulator, etc.). In this case, the additional device connection 128′″ is omitted.

FIG. 9 shows a perspectival view of a product family of the flowmeters 1a, 1b, 1c according to the invention. The flowmeters 1a, 1b, 1c have sensors 20a, 20b, 20c that each have different measuring tube nominal diameters. The measuring tube nominal diameters are selected from a nominal diameter range of 15 to 300 millimeters. The use of the transmitter according to the invention can also be advantageous for separate variants (see FIGS. 5, 6, and 8) for nominal diameters that differ from these. While the sensor housings 22a, 22b, 22c of the flowmeters 1a, 1b, 1c differ in their dimensions and/or housing geometry, these each have identically designed sensor-transmitter interfaces, so that transmitters 30a, 30b, 30c and/or transmitter adapters (not shown) can be or are connected that are designed identically for all different sensor housings 22a, 22b, 22c.

FIG. 10 shows a cross-section through a magnetic inductive flowmeter 1000. The magnetic inductive flowmeter 1000 has a sensor measuring unit 1070 which is configured to determine a flow-velocity-dependent measured variable of a medium which is guided through a measuring tube 1001. The measuring tube 1001 can be made of plastic, glass, or ceramic or can have a metallic support tube which has an electrically insulating inner lining (liner) made of plastic, ceramic, or glass on its inner surface. In order to determine the flow-velocity-dependent measured variable, the sensor measuring unit 1070 has a magnetic-field-generating device 1010 and at least two measuring electrodes 1030, 1031 for tapping a flow-velocity-dependent measuring voltage in the medium to be guided. In the embodiment shown, the magnetic-field-generating device 1010 is a two-coil system comprising two coils, each with a pole piece, which are arranged opposite one another on the measuring tube 1001, and a magnetic field guide system which mechanically connects the two coils to one another. Alternatively, the magnetic-field-generating device 1070 can also have only one coil or comprise at least one, or exactly two, saddle coils. If saddle coils are provided, the magnetic field guidance system can be omitted. The two measuring electrodes 1030, 1031 are each arranged in an opening in the measuring tube 1001 such that they are in contact with the medium when the medium is flowing. Alternatively, the measuring electrodes 1030, 1031 can also be configured to capacitively determine a flow-velocity-dependent measured variable. In this case, the measuring tube 1001 would be completely electrically insulating, and the measuring electrodes 1030, 1031 would not come into contact with the medium to be guided. Alternatively, more than two measuring electrodes 1030, 1031 can also be provided.

The sensor measuring unit 1070 itself is arranged in a sensor housing 1022 such that it is substantially completely enclosed or concealed by the measuring tube 1001 radially and parallel to a longitudinal direction of the tube.

The magnetic inductive flowmeter 1000 further has a transmitter 1020 arranged at the sensor-transmitter interface 1024 of the sensor housing 1022. The transmitter 1020 has two circuit boards 1032′, 1032″ which are arranged substantially parallel to each other inside the transmitter housing 1033. The radio module 1133 is arranged on the circuit board 1032′, via which module the communication of sensor and/or process data with an external unit takes place. Alternatively, three or more circuit boards can be provided. This may be necessary in particular if more space is required because larger distances between the electronic components and device connections are necessary. Alternatively, the third circuit board can be arranged non-parallel to the other two circuit boards arranged in parallel 1032′, 1032″, i.e., for example, at 90°or 45°.

1-15. (canceled)

16. A flowmeter for determining a flow-velocity-dependent measured variable, comprising:
a sensor for determining a process variable of a medium,
wherein the sensor has a measuring tube for guiding the medium,
wherein the sensor has at least one sensor measuring unit for determining the process variable of the medium,
wherein the sensor has a sensor housing which is arranged on an outer surface of the measuring tube,
wherein the sensor measuring unit is at least partially arranged in the sensor housing,
wherein the sensor has sensor electronics which are configured to operate the at least one sensor measuring unit with an operating signal and to determine the process variable depending upon a measuring signal provided by the at least one sensor measuring unit,
a transmitter,
wherein the transmitter has a transmitter housing,
wherein the transmitter housing has a transmitter housing cover which forms the front portion of the transmitter housing,
wherein the sensor electronics are arranged in the transmitter housing cover,
wherein the transmitter the transmitter housing cover is designed such that it can be arranged directly on a sensor-transmitter interface of the sensor housing and also on an transmitter holder which is external relative to the sensor housing,
wherein the transmitter housing cover is configured to be arranged on the sensor-transmitter interface or the transmitter holder,
wherein the transmitter has transmitter electronics which are in communication with the sensor electronics,
wherein the transmitter electronics are arranged in the transmitter housing,
wherein the transmitter electronics comprise a radio module for supporting a radio standard, wherein the radio module is configured to form a wireless connection between the transmitter electronics and an external receiver.

17. The flowmeter according to claim 16,
wherein the transmitter housing cover has a housing cover base body,
wherein the housing cover base body delimits a housing cover cavity and has an open end,
wherein the sensor electronics are arranged exclusively in the housing cover cavity.

18. The flowmeter according to claim 16,
wherein the transmitter housing cover has a display,
wherein the display is arranged in the transmitter housing cover in such a way that it can be viewed through a viewing window in a front surface of the transmitter housing cover.

19. The flowmeter according to claim 16, comprising:
a transmitter adapter which is arranged on the sensor housing,
wherein the transmitter adapter comprises an adapter housing,
wherein the transmitter adapter has adapter electronics which are arranged at least partially in the adapter housing and are in communication with the transmitter electronics and the sensor electronics,
wherein communication between the sensor measuring unit and the sensor electronics always takes place via the adapter electronics.

20. The flowmeter according to claim 19,
wherein the adapter housing has dimensions and/or housing geometry identical to those of the transmitter housing.

21. The flowmeter according to claim 16,
wherein the transmitter housing has a transmitter cover arranged on the rear side of the transmitter housing cover,
wherein the transmitter cover is designed such that the transmitter can be connected via it to the transmitter holder, in particular a support rail and preferably a top-hat rail.

22. The flowmeter according to claim 16,
wherein a width of the transmitter housing is less than 150 millimeters,
wherein a length of the transmitter housing is less than 250 millimeters.

23. The flowmeter according to claim 16,
wherein the sensor electronics and the transmitter electronics each have electronic components which are arranged on exactly one common circuit board.

24. The flowmeter according to claim 16,
wherein the sensor electronics and the transmitter electronics each have electronic components which are arranged on exactly two circuit boards.

25. The flowmeter according to claim 19,
wherein the sensor housing, the transmitter housing, and/or the adapter housing is/are made of cast aluminum.

26. The flowmeter according to claim 16,
wherein the sensor-transmitter interface is designed as a recess in the sensor housing,
wherein the transmitter and/or the transmitter adapter can be arranged in the recess.

27. The flowmeter according to claim 16,
wherein only the transmitter has a device connection.

28. The flowmeter according to claim 27,
wherein the device connection is arranged in the transmitter cover.

29. The flowmeter according to claim 16,
wherein the circuit carrier is a magnetic inductive flowmeter,
wherein the at least one sensor measuring unit has a magnetic-field-generating device and at least two measuring electrodes for tapping a flow-velocity-dependent measuring voltage in the medium to be guided.

30. A product family of flowmeters, comprising:
at least two flowmeters according to claim 16,
wherein the sensors of the flowmeters differ in their measuring tube nominal diameters,
wherein the measuring tube nominal diameter is selected from a nominal diameter range of 15 to 300 millimeters,
wherein the sensor housings of the flowmeters differ in their dimensions and/or housing geometry,
wherein the sensor housings each have identically designed sensor-transmitter interfaces, so that transmitters and/or transmitter adapters can be connected that are designed identically for all sensor housings.
